(19) United States
(12) Patent Application Publication
(10) Pub. No.: US 2012/0176330 A1
(43) Pub. Date: Jul. 12, 2012

(54) TOUCH MODULE AND ANALYZING METHOD FOR TOUCHING COORDINATION THEREOF

(75) Inventors: Sean CHANG, Taoyuan Hsien (TW); Chin-Wei KUO, Taoyuan Hsien (TW)

(73) Assignee: DELTA ELECTRONICS, INC.

(21) Appl. No.: 13/348,269

(22) Filed: Jan. 11, 2012

(30) Foreign Application Priority Data
Jan. 12, 2011 (TW) 100101056

(51) Int. Cl. G06F 3/041

(52) U.S. Cl. 345/173; 178/18.03

(57) ABSTRACT

A touch module and an analyzing method for a touching coordinate are disclosed. The touch module includes a plurality of sensing lines, which includes a first sensing line, a second sensing line and a third sensing line. The second sensing line is located between the first sensing line and the third sensing line. The analyzing method includes the steps of: calculating a first calculation value according to a first sensing signal from the first sensing line and a second sensing signal from the second sensing line; calculating a second calculation value according to the second sensing signal and a third sensing signal from the third sensing line; and calculating a touching coordinate value according to the first calculation value, the second calculation value and a reference value.

### CROSS REFERENCE TO RELATED APPLICATIONS

This Non-provisional application claims priority under 35 U.S.C. §119(a) on Patent Application No(s). 100101056 filed in Taiwan, Republic of China on Jan. 12, 2011, the entire contents of which are hereby incorporated by reference.

### BACKGROUND OF THE INVENTION

1. Field of Invention

The invention relates to a touch module and an analyzing method for a touching coordinate thereof.

2. Related Art

With the electronic products, which have been developed to be thin and to satisfy the requirement for users to operate more conveniently, touch panels have been widely applied to various electronic products, such as mobile phones, home appliances, computers and play stations.

The conventional touch panel has a plurality of sensing lines and a control unit coupled to each sensing line. When the user touches the touch panel, signals of some sensing lines are changed, and the control unit compares the sensing signals of all the sensing lines with one another, and determines the sensing line with the highest sensing signal as the touching coordinate.

However, the touching coordinate, obtained by the conventional touch panel, must fall on the sensing line. If the more precise coordinate has to be determined, more sensing lines with the smaller gaps have to be provided, and the cost is thus increased. It is therefore a subject of the invention to provide a touch module, which can use the relatively small number of sensing lines and can provide the precise touching coordinate positioning, and an analyzing method for a touching coordinate thereof.

### SUMMARY OF THE INVENTION

In view of the foregoing, an objective of the invention is to provide a touch module, which can use the relatively small number of sensing lines and can provide the precise touching coordinate positioning, and an analyzing method for a touching coordinate thereof.

To achieve the above objective, the invention discloses an analyzing method for a touching coordinate of a touch module. The touch module includes a plurality of sensing lines including a first sensing line, a second sensing line and a third sensing line. The second sensing line is located between the first sensing line and the third sensing line. The analyzing method includes the following steps of: calculating a first calculation value according to a first sensing signal from the first sensing line and a second sensing signal from the second sensing line; calculating a second calculation value according to the second sensing signal and a third sensing signal from the third sensing line; and calculating a touching coordinate value according to the first calculation value, the second calculation value and a reference value.

In one embodiment of the invention, the first calculation value is obtained by performing addition, subtraction, multiplication, division, factorial or function calculating according to the first sensing signal and the second sensing signal, and the second calculation value is obtained by performing addition, subtraction, multiplication, division, factorial or function calculating according to the second sensing signal and the third sensing signal. The invention can adopt different calculation methods, such as addition, subtraction, multiplication, division, factorial or function calculation according to the weighting coefficients or other factors of the first sensing signal and the second sensing signal, which may relate to the relative position between the first sensing line and the second sensing line. The same rules are also adapted to the second sensing signal and the third sensing signal.

In one embodiment of the invention, when the reference value ranges between the first calculation value and the second calculation value, the touching coordinate value is obtained by way of calculating. One specific aspect of the analyzing method for the touching coordinate of the invention adopts the zero-crossing. When the first calculation value and the second calculation value are located on two sides of the reference value, it is obtained that a touching coordinate is located between the first sensing line and the third sensing line.

In one embodiment of the invention, the first calculation value and the second calculation value constitute a linear equation, a quadric equation or a polynomial equation; and the reference value is a real number or a value obtained by a linear equation, a quadric equation or a polynomial equation. The invention can adopt different calculation methods according to the weighting coefficients or other factors of the first calculation value and the second calculation value. For example, the first calculation value and the second calculation value constitute the linear equation, quadric equation or polynomial equation for the calculation of the touching coordinate. The weighting coefficients or other factors of the first calculation value and the second calculation value may relate to the relative positions between the first sensing line, the second sensing line and the third sensing line.

In one embodiment of the invention, the touching coordinate value is obtained from an intersection of a line, constituted by the first calculation value and the second calculation value, and a line, constituted by the reference value. When the first calculation value and the second calculation value form the zero-crossing or base-value-crossing, the touching coordinate value may be obtained from the intersection of the line, constituted by the first calculation value and the second calculation value, and the line, constituted by the reference value. In addition, the invention also discloses a touch module including a plurality of sensing lines and a processing unit. The sensing lines includes a first sensing line, a second sensing line and a third sensing line, and the second sensing line is located between the first sensing line and the third sensing line. The first sensing line outputs a first sensing signal, the second sensing line outputs a second sensing signal, and the third sensing line outputs a third sensing signal. The processing unit is coupled to the first sensing line, the second sensing line and the third sensing line. The processing unit calculates a first calculation value according to the first sensing signal and the second sensing signal, calculates a second calculation value according to the second sensing signal and the third sensing signal, and calculates a touching coordinate value according to the first calculation value, the second calculation value and a reference value.

In one embodiment of the invention, the first sensing line and the third sensing line are symmetrical with respect to the second sensing line. In this case, the first and second calculation values have the same weight, so that the calculation of the touching coordinate value is easier.

In one embodiment of the invention, the processing unit includes a plurality of calculating elements and a control element. The calculating elements at least include a first calculating element and a second calculating element. The first calculating element is coupled to the first sensing line and the second sensing line and calculates the first calculation value, and the second calculating element is coupled to the second sensing line and the third sensing line and calculates the second calculation value. The control element is coupled to the calculating elements and calculates the touching coordinate value according to the first calculation value, the second calculation value and the reference value.

As mentioned above, the first calculation value, calculated by the invention, represents the relationship between the first sensing signal and the second sensing signal, and the second calculation value represents the relationship between the second sensing signal and the third sensing signal. The touching coordinate value, calculated according to the first calculation value, the second calculation value and the reference value, does not necessarily fall on the first sensing line, the second sensing line or the third sensing line, and may fall between the first, second and third sensing lines, and reflect the actual touched position of the user. Thus, the invention can obtain the more precise touching coordinate using the relatively fewer sensing lines, so that the cost can be reduced, and the product competition ability can be enhanced.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic illustration showing a touch module according to a preferred embodiment of the invention;

FIG. 2 is a flow chart showing an analyzing method for a touching coordinate according to a preferred embodiment of the invention;

FIG. 3 is a schematic illustration showing relationships between a first calculation value, a second calculation value and a reference value according to the preferred embodiment of the invention;

FIG. 4 is another schematic illustration showing a touch module according to the preferred embodiment of the invention; and

FIG. 5 shows the relationships between a sensing signal and a calculation value with sensing lines L11 to L1A as illustrative examples.

### DETAILED DESCRIPTION OF THE INVENTION

The present invention will be apparent from the following detailed description, which proceeds with reference to the accompanying drawings, wherein the same references relate to the same elements.

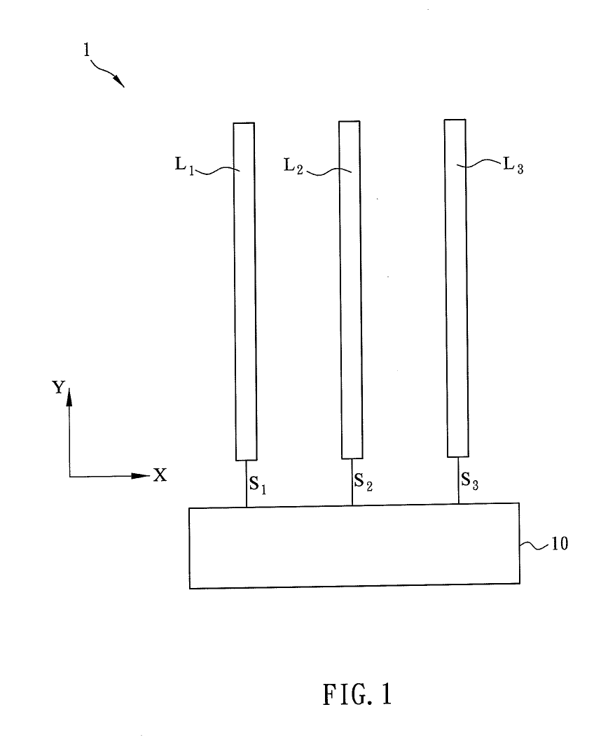

FIG. 1 is a schematic illustration showing a touch module 1 according to a preferred embodiment of the invention. The type of the touch module 1 of the invention may include, without limitation to, the optical, ultrasonic, infrared, capacitive or resistive type of touch module.

The touch module 1 includes a plurality of sensing lines, which includes a first sensing line L₁, a second sensing line L₂ and a third sensing line L₃. The second sensing line L₂ is located between the first sensing line L₁ and the third sensing line L₃. When the user touches the touch module 1, the first sensing line L₁ can output a first sensing signal S₁, the second sensing line L₂ can output a second sensing signal S₂, and the third sensing line L₃ can output a third sensing signal S₃.

The touch module 1 further includes a processing unit 10, which is coupled to the first sensing line L₁, the second sensing line L₂ and the third sensing line L₃, and calculates a touching coordinate value, corresponding to a position touched by the user, according to the first sensing signal S₁, the second sensing signal S₂ and the third sensing signal S₃.

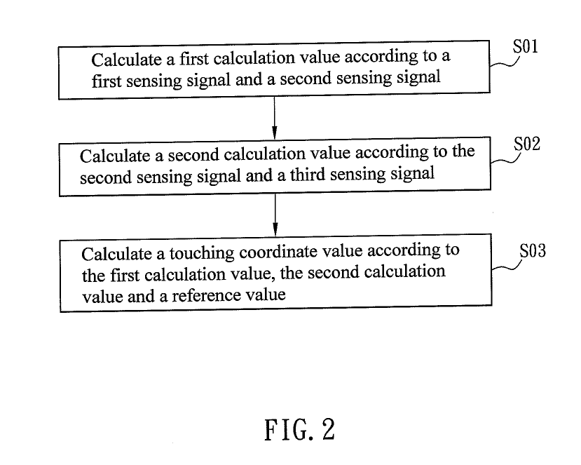

FIG. 2 shows an analyzing method for a touching coordinate according to the preferred embodiment of the invention. The analyzing method includes steps S01 to S03. The touch module 1 and the analyzing method for the touching coordinate thereof will be further described with reference to FIGS. 1 and 2.

First, in the step S01, the processing unit 10 calculates a first calculation value C₁ according to the first sensing signal S₁ and the second sensing signal S₂. The first calculation value C₁ may be obtained by performing the addition, subtraction, multiplication, division, factorial or function calculation according to the first sensing signal S₁ and the second sensing signal S₂. In this embodiment, the first calculation value C₁ is equal to the second sensing signal S₂ minus the first sensing signal S₁, that is, C₁=S₂−S₁.

In the step S02, the processing unit 10 calculates the second sensing signal S₂ and the third sensing signal S₃ to obtain a second calculation value C₂, which may be obtained by performing the addition, subtraction, multiplication, division, factorial or function calculation according to the second sensing signal S₂ and the third sensing signal S₃. In this embodiment, the second calculation value C₂ is equal to the third sensing signal S₃ minus the second sensing signal S₂. That is, C₂=S₃-S₂.

In the step S03, the processing unit 10 calculates the touching coordinate value according to the first calculation value C₁, the second calculation value C₂ and a reference value. The reference value may be a real number, or a value obtained by a linear equation, a quadric equation or a polynomial equation. For example, the first sensing line and the third sensing line may be symmetrical with respect to the second sensing line. In this case, the first calculation value C₁ and the second calculation value C₂ have the same weight, so that the calculation of the touching coordinate value is easier.

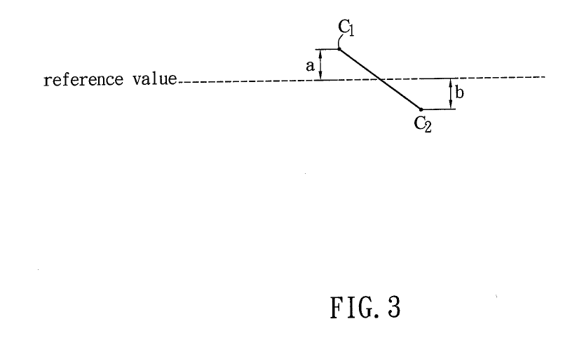

FIG. 3 is a schematic illustration showing relationships between the first calculation value C₁, the second calculation value C₂ and the reference value according to the preferred embodiment of the invention. When the user does not touch the touch module 1, generally speaking, the first sensing signal S₁, the second sensing signal S₂ and the third sensing signal S₃ are equal to one another. So, the first calculation value C₁ in the untouched state is equal to the second sensing signal S₂ minus the first sensing signal S₁, that is, C₁=S₂−S₁=0. Similarly, the second calculation value C₂=S₃−S₂=0, C₁=C₂=0 serving as the reference value, and lines, which are parallel lines in this example, are constituted. When the user touches the second sensing line or a portion near the second sensing line, the second sensing signal of the second sensing line is higher than the first sensing signal of the first sensing line and the third sensing signal of the third sensing line. That is, the first calculation value C₁=S₂−S₁=a>0, and the second calculation value C₂=S₃−S₂=−b<0.

Again, it is assumed that the first calculation value and the second calculation value of this embodiment constitute the linear equation (straight line), the coordinate represented by the first sensing line is A, the coordinate represented by the second sensing line is B, and the coordinate represented by the third sensing line is C, wherein the absolute value of (C−A) is equal to D. The processing unit 10 calculates the touching coordinate value E according to the equation of “touching coordinate value E=A+D*C/(C₁−C₂)”.

In addition, the first calculation value and the second calculation value may also constitute a quadric equation or a polynomial equation. The processing unit 10 may also correspondingly calculate the touching coordinate value.

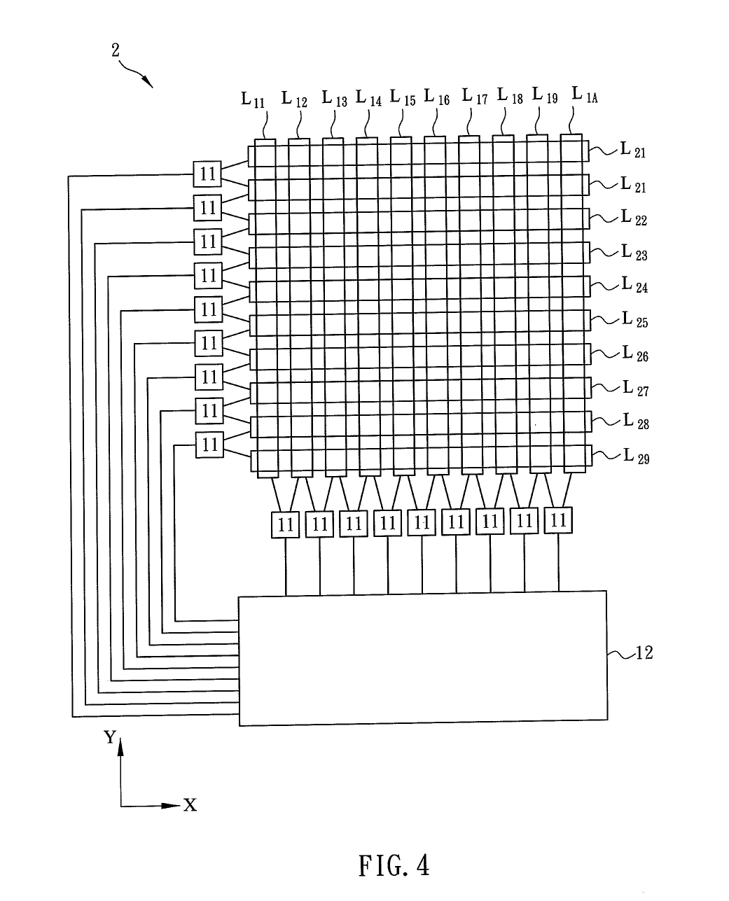

FIG. 4 is another schematic illustration showing a touch module 2 using the analyzing method for the touching coordinate according to the preferred embodiment of the invention. The touch module 2 includes a plurality of sensing lines, wherein a portion of the sensing lines L₁₁ to L_{1A} is disposed in parallel in the X-axis direction with the equal gaps; and the other portion of the sensing lines L₂₁ to L₂₉ is disposed in parallel in the Y-axis direction with the equal gaps.

The touch module 2 further includes a processing unit, which includes a plurality of calculating elements 11 and a control element 12. Each calculating element 11 is coupled to two sensing lines, receives the sensing signals thereof, and calculates the calculation value according to the sensing signals. The control element 12 receives the calculation value and calculates the touching coordinate value according to a reference value. In addition, the calculating element 11 may incorporate the control element 12 according to the requirement, so that the control element 12 has the function of the calculating element 11, and the number of elements used may be reduced.

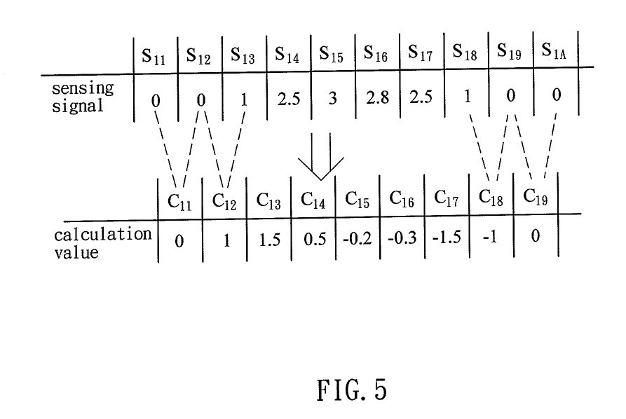

FIG. 5 shows the relationships between a sensing signal and a calculation value with sensing lines L₁₁ to L_{1A} as illustrative examples. The sensing signals S₁₁ to S_{1A} sequentially come from the sensing lines L₁₁ to L_{1A}. When the calculating elements 11 receive the sensing signals S₁₁ to S_{1A}, the calculation values C₁₁ to C₁₉ are respectively calculated, wherein C₁₁=S₁₂−S₁ᵢ=0, C₁₂=S₁₃−S₁₂=1, and the other C₁₃ to C₁₉ may be obtained in a similar manner. In this embodiment, the reference value is set to 0, so it is obtained that the touching coordinate falls between the sensing lines L₁₄ and L₁₆ in the case where C₁₄ and C₁ₛ constitute the zero-crossing. According to the above-mentioned formula, it is obtained that the touching coordinate is X₁+(|X₂-X₁|)*0.5/(0.5+0.2), wherein X₁ and X₂ are the predetermined coordinates of the sensing lines L₁₄ and L₁₆.

The calculation of the touching coordinate value of the X-axis direction has been described hereinabove, and the calculation of the touching coordinate value of the Y-axis direction may be obtained according to the same rule. In addition, the invention may further be applied to the analyzing method of the multi-touching coordinate. At this time, the touch module can obtain multiple touching coordinate values according to the analyzing method for the touching coordinate.

No matter how dense the sensing lines of the conventional touch module are, when the user is operating the conventional touch module, the possibility that the center of his/her finger just presses the middle of the sensing line is very low. More particularly, the possibility is even lower in the handwriting or traversing condition. So, the user's touch position, provided by the conventional touch module, is not the user's actual touch position, but is the coordinate of the touch position sometimes with the positive offset and sometimes with the negative offset. This phenomenon causes the rear-end system to incorrectly judge the signals.

Compared with the prior art, the touching coordinate outputted from the touch module of this invention precisely calculates the user's touch position. So, the touch module of this invention can precisely position the user's actual touch position, and thus prevent the rear-end system from incorrectly judging the signals. Moreover, the invention can obtain the more precise touching coordinate using the relatively fewer sensing lines, so that the cost can be reduced, and the product competition ability can be enhanced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An analyzing method for a touching coordinate of a touch module, the touch module comprising a plurality of sensing lines, the sensing lines comprising a first sensing line, a second sensing line and a third sensing line, the second sensing line being located between the first sensing line and the third sensing line, the analyzing method comprising the steps of:
calculating a first calculation value according to a first sensing signal from the first sensing line and a second sensing signal from the second sensing line;
calculating a second calculation value according to the second sensing signal and a third sensing signal from the third sensing line; and
calculating a touching coordinate value according to the first calculation value, the second calculation value and a reference value.

2. The method according to claim 1, wherein the first calculation value is obtained by performing addition, subtraction, multiplication, division, factorial or function calculating according to the first sensing signal and the second sensing signal, and the second calculation value is obtained by performing addition, subtraction, multiplication, division, factorial or function calculating according to the second sensing signal and the third sensing signal.

3. The method according to claim 1, wherein when the reference value ranges between the first calculation value and the second calculation value, the touching coordinate value is obtained by way of calculating.

4. The method according to claim 1, wherein the first calculation value and the second calculation value constitute a linear equation, a quadric equation or a polynomial equation; and the reference value is a real number or a value obtained by a linear equation, a quadric equation or a polynomial equation.

5. The method according to claim 1, wherein the touching coordinate value is obtained from an intersection of a line, constituted by the first calculation value and the second calculation value, and a line, constituted by the reference value.

6. The method according to claim 1, wherein when a coordinate represented by the first sensing line is A, a coordinate represented by the third sensing line is C, an absolute value of (C−A) is D, the first calculation value C₁ is greater than the reference value and the second calculation value C₂ is smaller than the reference value, the touching coordinate value is obtained according to an equation of A+D*C₁/(C₁−C₂).

7. A touch module, comprising:
a plurality of sensing lines comprising a first sensing line, a second sensing line and a third sensing line, wherein the second sensing line is located between the first sensing line and the third sensing line, the first sensing line outputs a first sensing signal, the second sensing line outputs a second sensing signal, and the third sensing line outputs a third sensing signal; and
a processing unit coupled to the first sensing line, the second sensing line and the third sensing line, wherein the processing unit calculates a first calculation value according to the first sensing signal and the second sensing signal, calculates a second calculation value according to the second sensing signal and the third sensing signal, and calculates a touching coordinate value according to the first calculation value, the second calculation value and a reference value.

8. The touch module according to claim 7, wherein the first calculation value is obtained by performing addition, subtraction, multiplication, division, factorial or function calculating according to the first sensing signal and the second sensing signal, and the second calculation value is obtained by performing addition, subtraction, multiplication, division, factorial or function calculating according to the second sensing signal and the third sensing signal.

9. The touch module according to claim 7, wherein when the reference value ranges between the first calculation value and the second calculation value, the processing unit obtains the touching coordinate value by way of calculating.

10. The touch module according to claim 7, wherein the first calculation value and the second calculation value constitute a linear equation, a quadric equation or a polynomial equation; and the reference value is a real number or a value obtained by a linear equation, a quadric equation or a polynomial equation.

11. The touch module according to claim 7, wherein the touching coordinate value is obtained from an intersection of a line, constituted by the first calculation value and the second calculation value, and a line, constituted by the reference value.

12. The touch module according to claim 7, wherein when a coordinate represented by the first sensing line is A, a coordinate represented by the third sensing line is C, an absolute value of (C−A) is D, the first calculation value C₁ is greater than the reference value and the second calculation value C₂ is smaller than the reference value, the touching coordinate value is obtained according to an equation of A+D*C₁/(C₁−C₂).

13. The touch module according to claim 7, wherein the first sensing line and the third sensing line are symmetrical with respect to the second sensing line.

14. The touch module according to claim 7, wherein the processing unit comprises:
a plurality of calculating elements comprising a first calculating element and a second calculating element, wherein the first calculating element is coupled to the first sensing line and the second sensing line and calculates the first calculation value, and the second calculating element is coupled to the second sensing line and the third sensing line and calculates the second calculation value; and
a control element, which is coupled to the calculating elements and calculates the touching coordinate value according to the first calculation value, the second calculation value and the reference value.
